(19) United States
(12) Patent Application Publication
(10) Pub. No.: US 2008/0043372 A1
(43) Pub. Date: Feb. 21, 2008

(54) Magnetic disk drive and head slider

(75) Inventor: Toru Shimozato, Kawasaki (JP)

Correspondence Address: Patrick G. Burns, Esq.;GREER, BURNS & CRAIN, LTD., Suite 2500, 300 South Wacker Dr, Chicago, IL, 60606, US

(73) Assignee: FUJITSU LIMITED

(21) Appl. No.: 11/732,458

(22) Filed: Apr. 3, 2007

(30) Foreign Application Priority Data
Aug. 17, 2006 (JP) 2006-222717

(51) Int. Cl. G11B 21/21

(52) U.S. Cl. 360/235.1

(57) ABSTRACT

A head slider includes a positive pressure generating portion constituting an air bearing surface that is formed at land portions higher than a base surface of a head slider body formed opposite to a storage medium by a predetermined difference in level, and that generates a positive pressure; a head element portion formed in the vicinity of an air flowing-out edge of the slider body for making an access to a recording medium; and expansion portions constituting expansion members that have a higher thermal expansion coefficient than that of a constituent material of land portions and that expand/contract in response to change of environmental temperature.

### BACKGROUND OF THE INVENTION

1. Field of the Invention

The present invention relates to a magnetic disk drive, and more specifically to a magnetic disk drive having a head slider floating a head element over a medium in the magnetic disk drive.

2. Description of the Related Art

The magnetic disk drive now requires a larger storage capacity and a smaller size. Effective means for increasing the storage capacity and reducing the size of the magnetic disk drive is to increase the recording density of a storage medium in the magnetic disk drive. In order to increase the recording density, it is necessary to write data in minute areas on the storage medium or read data from minute areas thereon. To write data in minute areas or read data from minute areas on the storage medium, the head element portion itself, which performs writing and reading, must be miniaturized. Furthermore, since data must be correctly written in the minute areas, a space between the storage medium, on which data is stored, and the head element portion must be reduced. This space is referred to as a “fly height”.

On the other hand, peripheries of the head element portion deform in response to change in temperature thereof. When peripheries of the head element portion expand due to heat, the head element portion projects toward the storage medium. This projection of the head element portion reduces the fly height, thereby raising a possibility that the head element portion may collide against the storage medium. Therefore, the design of the fly height must allow for thermal deformation of the peripheries of the head element portion. This constitutes a factor inhibiting an increase in the capacity of the magnetic disk drive.

With this being the situation, various approaches to reducing the fly height has been proposed. One method for reducing the fly height of the head element portion is the dynamic fly height (DFH) method. In this method, a heater is arranged in the peripheries of the head element portion and energized, so that the head element portion is expanded toward the storage medium when data is written and read, to thereby dynamically vary the fly height of head element portion over the storage medium. Japanese Unexamined Patent Application Publications Nos. 2005-276284 and 2004-241092 are disclosed as known examples using this method.

However, the head element portion that has projected toward the recording medium causes the head slider to generate a force that moves the head element portion away from the storage medium by means of airflow. This generated force has an influence on the fly height of the head element portion. This being the case, a heater is arranged at a position where the force generates in the surface of an air bearing in the head slider to expand the bearing surface, thereby dynamically controlling the fly height in response to a positive pressure generated by the projection of the head element portion. In the DFH method, the head element portion is brought close to the recording medium during data writing/reading, so that the head element portion is prone to a collision against the recording medium, adhesion of foreign matter, or the like.

The prior art requires electric power, wiring, and control means for energizing the heater in order to control the fly height of the head slider. This complicates the structure of the head slider, and necessitates electric power for controlling the energization. Moreover, the prior art needs means for detecting the fly height of the head element portion in order to control the energization of the heater. The prior art determines the fly height of the head element portion by detecting a collision of the magnetic disk drive against the storage medium or a reproduction error of magnetic information. However, in the prior art, since the fly height is detected and the heater is energized after there has occurred the collision of magnetic disk drive against the storage medium or the reproduction error of magnetic information, it is impossible to prevent an error before it occurs. In the prior art, as a result of the occurrence of the error, the storage medium or the head element portion might be suffer damage.

### SUMMARY OF THE INVENTION

Accordingly, it is an object of the present invention to provide a head slider and a storage unit that keep constant the fly height of a head element irrespective of changes in temperature of peripheries of the head element portion.

The head slider according to the present invention is configured as follows. The head slider for reading or writing a data to a recording medium comprise: a major surface of said head slider to be placed opposite to said storage medium; a first land portion protruding from said major surface by a predetermined height, for generating a upper force bringing said head slider away from said storage medium by an air flow passing through between said head slider and said storage medium; and a second land portion protruding from said major surface by a height lower than said predetermined height and positioned downstream said first land potion, for generating a down force bringing said head slider close to said storage medium, said second land portion having an expansion material, said expansion material having a higher thermal expansion coefficient than a constituent material of said first land portion.

With these features, even if the environmental temperature varies, the head slider according to the present invention allows the fly height over the storage medium to be kept constant without the need to use fly height detecting means or heating means such as a heater, and without any power consumption.

### BRIEF DESCRIPTION OF THE DRAWINGS

FIG. 1 is a schematic diagram of a magnetic disk drive 100 according to a first embodiment of the present invention;

FIG. 2 is an enlarged view of a head slider in the first embodiment;

FIG. 3 is a diagram of the surface of the head slider opposite to a storage medium in the first embodiment;

FIG. 4 is an enlarged side view of the vicinity of a head element portion;

FIG. 5 is an enlarged side view of the vicinity of the head element portion;

FIG. 6 is an enlarged side view of the vicinity of the head element portion;

FIG. 7 is a graph showing changes in distances plotted against the environmental temperature;

FIG. 8 is a diagram of the surface of the head slider opposite to the storage medium in a second embodiment of the present invention; and

FIG. 9 is a diagram of the surface of a head slider opposite to a storage medium in the conventional embodiment.

### DESCRIPTION OF THE PREFERRED EMBODIMENTS

A magnetic disk drive and a magnetic head slider according to a first embodiment of the present invention will be described with reference to accompanying drawings.

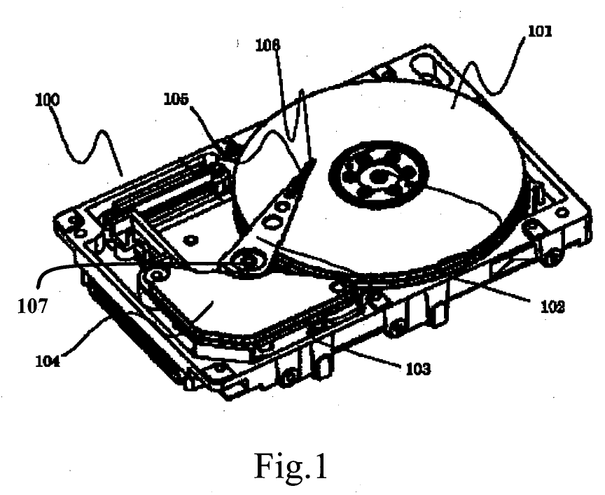

FIG. 1 is a schematic diagram of the magnetic disk drive 100 according to this embodiment. The magnetic disk drive 100 is of a substantially rectangular parallelepiped shape. The magnetic disk drive 100 includes various constituent members in its cabinet. The cabinet is connected to a lid (not shown), and the cabinet connected to the lid is enclosed. The inside of the cabinet is prevented from the entry of dust from the outside. A storage medium 101 stores data. The storage medium 101 is rotationally driven by a spindle motor 102. An actuator mechanism 103 is connected to a pivot 107 that vertically extends. The actuator mechanism 103 performs a rotational motion about the pivot 107 using a voice coil motor 104. The actuator mechanism 103 is connected to a head suspension mechanism 105 at the front end thereof. The head suspension mechanism 105 pivots the magnetic head slider 201 in the vicinity of the front end thereof. The head suspension mechanism 105 supports the magnetic head slider 201, and in addition, generates a predetermined force that presses the magnetic head slider 201 against the storage medium 101.

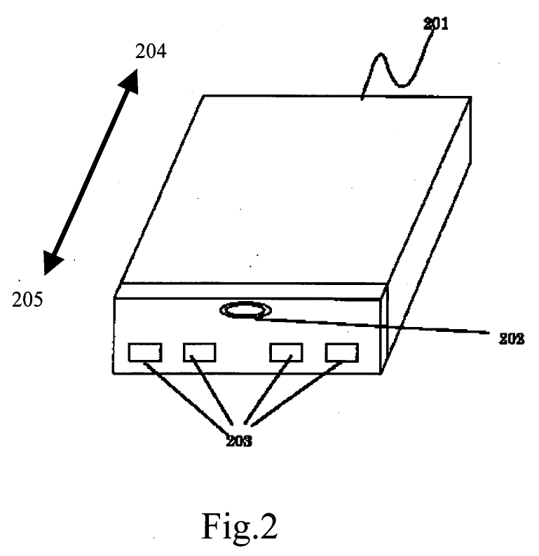

Next, the shape of the magnetic head slider 201 will be explained. FIG. 2 shows the shape of the head slider 201 according to this embodiment. The magnetic head slider 201 has a substantially rectangular parallelepiped shape. The longitudinal size of the magnetic head slider 201 is on the level of 0.85 mm. The widthwise size is on the level of 0.7 mm. The thicknesswise size of the magnetic head slider 201 is on the level of 0.23 mm. In the longitudinal direction of the magnetic head slider 201, air flows from the side of an air flowing-in edge 204 toward the side of an air flowing-out edge 205. A slider body 2011 is formed by a sintered body composed of Al, Ti, and C, i.e., so-called AlTiC sintered body. A head element peripheral portion 2012 is formed by alumina (Al₂O₃). The head element peripheral portion 2012 has a plurality of terminal portions 203 at predetermined positions on the side of the air flowing-out edge 205. The terminal portions 203 are terminals for data signals to be written on a magnetic head element portion 202 and the storage medium 101, or data signals to be read from the storage medium 101.

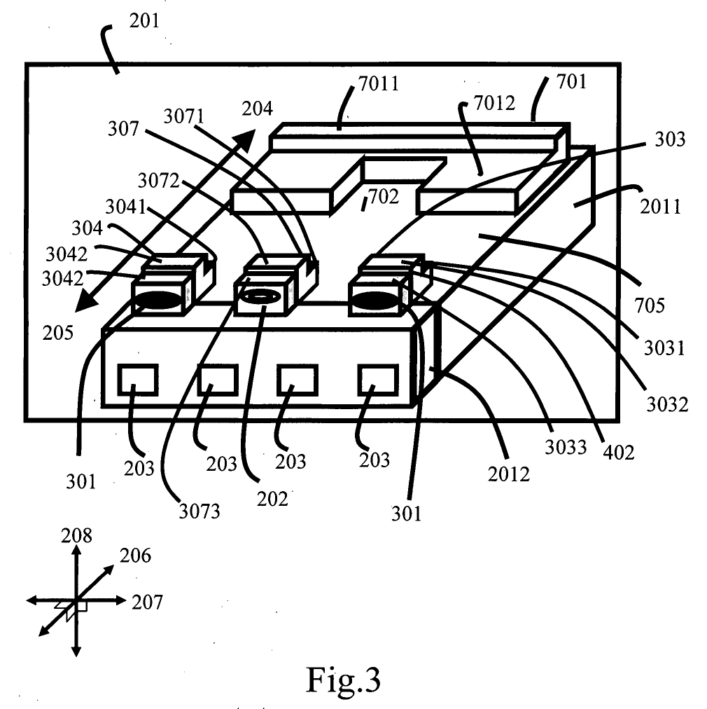

Here, the shape of an air bearing surface 705 of the magnetic head slider 201 will be described air bearing surface 705 is one of a major surfaces. FIG. 3 shows the shape of the air bearing surface 705 of the magnetic head slider 201 according to this embodiment. The air bearing surface 705 is a surface opposite to the storage medium 101 of the magnetic head slider 201. The air bearing surface 705 includes a first land portion 701, a groove portion 702, a second land portion 307, a third land portion 303, and a fourth land portion 304. Each of the land portions protrudes the air bearing surface 705. Each of the land portions is formed higher than the air bearing surface 705 by a predetermined height.

The predetermined height is designed so that each of the land portions has a shape that generates a pressure for keeping constant the fly height of the head element of the magnetic head slider 201.

The first land portion 701 is formed higher than the air bearing surface 705 by a predetermined level in height. The first land portion 701 is of a step shape. A first step 7011 of the first land portion 701 causes the magnetic head slider 201 to generate a positive pressure. This positive pressure constitutes a force acting in the direction that moves the magnetic head slider 201 away from the storage medium 101. A second step 7012 of the first land portion 701 and the groove portion 702 cause the magnetic head slider 201 to generate a negative pressure, because air compressed by the first step 7011 expands in the groove portion 702. This negative pressure constitutes a force acting in the direction that brings the magnetic head slider 201 close to the storage medium 101.

The second land portion 307 is disposed on the side of the air flowing-out edge 205 of the magnetic head slider 201. The second land portion 307 is formed higher than the air bearing surface 705 by a predetermined level in height. The second land portion 307 is of a step shape. The second land portion 307 has a first step 3071, a second step 3072 and a third step 3072. On the third step 3073 of the second land portion 307, there is provided a magnetic head element portion. The magnetic head portion 202 is covered with a protective film formed of Alumina.

The magnetic head element portion 202 is a composite head comprising a head element for reproduction, such as a giant magneto resistive (GMR) element using a magnetic resistance effect in which the electric resistance varies in response to a magnetic field, or a tunnel magneto resistive (TMR) element using a tunnel magnetic resistance effect; and an inductive head that is formed of an alloy such as NiFe for recording and that is used for writing data on the storage medium 101 using a magnetic field generated in a magnetic coil. In this embodiment, the magnetic head element portion 202 using the GMR head or TMR head is explained as an example. However, the present invention is not limited to this type of magnetic head element but may include other known types that perform the required functions.

The air bearing surface 705 of the magnetic head slider 201 includes a third land portion 303 and a fourth land portion 304. The third land portion 303 and the fourth land portion 304 are disposed on the side of the air flowing-out edge 205 of the magnetic head slider 201. The third land portion 303 and the fourth land portion 304 are formed higher than the air bearing surface 705 by a predetermined level in height. The third land portion 303 and the fourth land portion 304 are each of a step shape.

The third land portion 303 has a first step 3031, a second step 3032 and a third step 3033. The third step of each of the third land portion 303 and the fourth land portion 304 has an expansion member 301.

The expansion member 301 has a thermal expansion coefficient higher than that of a material constituting the third land portion 303 and the fourth land portion 304 in each of which the expansion member 301 is arranged. The thermal expansion coefficient of the material constituting the third land portion 303 and the fourth land portion 304 is, for example, about 7×10⁻⁶/° C. provided that the material is AlTiC or alumina. The expansion members 301 with respect to the third land portion 303 and the fourth land portion 304 may be each formed by, for example, an electric conductor such as copper (17×10⁻⁶/° C.) or iron (12×10⁻⁶/° C.), or an alloy.

The expansion members 301 each expands/contracts in accordance with a change in the environmental temperature. Consequently, the magnetic head slider 201 changes in the concavity/convexity of the air bearing surface 705 without using energizing means from the outside. As a result of the expansion/contraction of the expansion members 301 and the deformation of the magnetic head slider 201, the 201 obtains a positive pressure of required magnitude.

The expansion members 301 are disposed symmetrically with respect to a center line parallel to the longitudinal direction of the magnetic head slider 201, the center line passing through the magnetic head element portion 202 disposed in the vicinity of the center of the air flowing-out edge 205.

Because the magnitude of the positive pressure generated in the magnetic head slider 201 becomes symmetric with respect to the center line parallel to the longitudinal direction of the magnetic head slider 201, it is possible to adjust the fly height without affecting the floating posture of the magnetic head slider 201. In order to cause the magnetic head slider 201 to generate a positive pressure of a required magnitude by the expansion members 301, the expansion members 301 should be each arranged so as to have an area of a required size at a predetermined position. The area of the required size is predetermined in accordance with a thermal expansion coefficient and a positive or a negative pressure generated as a result of expansion of the expansion members 301.

For example, if the thermal expansion coefficient of a material of the expansion members is higher than the material constituting the third land portion 303 and the fourth land portion 304 but the value itself of the expansion coefficient is low as in the case with that of iron compared with that of copper, then, the positive pressure of the required magnitude can be generated by increasing the footprint of each of the expansion members 301 of the magnetic head slider 201. In contrast, if the thermal expansion coefficient of the material of the expansion members is high as in the case with that of copper compared with that of iron, then, the positive pressure of the required magnitude can be generated by a reduced footprint of each of the expansion members of the magnetic head slider 201. Therefore, in the magnetic head slider 201, it is recommendable to arrange desirable expansion members 301 as appropriate so as to each take an area of the required size, based on the shape and the like of a respective one of the land portions. In this embodiment, in each of the third land portion 303 and the fourth land portion 304, a copper material having dimensions on the level of 60 μm in width, 5 μm in thickness, and 25 μm in depth is provided as the expansion member 301. If an iron material is used as the expansion members 301, the footprint should be increased in accordance with the difference in the thermal expansion coefficient of the expansion member 301 between iron and copper.

The expansion members 301 are installed in a forming process of the head element peripheral portion 2012. The expansion members 301 can be installed at predetermined positions of the head element peripheral portion 2012 by adding processes of laminating resist films or the like. The installation of the expansion members 301 can be easily performed without the need for a significant change in the conventional forming process of the head element peripheral portion 2012.

The installation of the expansion members 301 is not limited to the method by the lamination of resist films. For example, the expansion members 301 may also be installed by embedding. Anyhow a desirable installation method may be adopted in accordance with the magnetic head slider 201. That is, the arrangement of the expansion members 301 is not restricted as long as the thermal expansion coefficient of the expansion members 301 is higher than those of other materials forming the magnetic head slider 201, such as AlTiC or alumina, and the materials of the head element portion, and as long as the expansion members 301 are disposed at the predetermined positions.

Next, operations of the magnetic disk drive 100 will be described.

The magnetic head slider 201 is loaded on the storage medium 101 that is rotating, and the magnetic head slider 201 floats over the storage medium 101. An air flow generating as a result of the rotation of the storage medium 101 flows from the side of the air flowing-in edge 204 of the air bearing surface 705 toward the side of the air flowing-out edge 205 thereof. Thus the magnetic head slider 201 floats over the storage medium 101. The fly height of the magnetic head slider 201 over storage medium 101 is higher on the side of the air flowing-in edge 204 than on the side of the air flowing-out edge 205. The floating posture of the magnetic head slider 201 over the storage medium 101 is referred to as a “wedge film shape”. The air flow that has flowed in between the magnetic head slider 201 and the storage medium 101 is compressed by the step shape of the first land portion 701. A positive pressure is caused by the air compressed by the step shape of the first land portion 701. Then, the air compressed by the step shape of the first land portion 701 vertically expands when entering the groove portion 702, thereby generating a negative pressure. As a result, the magnetic head slider 201 floats, while having a relatively high stiffness, over the rotating storage medium 101 by a balance among the above-described positive pressure and negative pressure, and a load force by a head suspension mechanism 105. The magnetic head slider 201 is moved to a predetermined position by a rotational operation of the actuator mechanism 103. The magnetic head element portion 202 of the magnetic head slider 201 performs writing/reading processing on/from the storage medium 101.

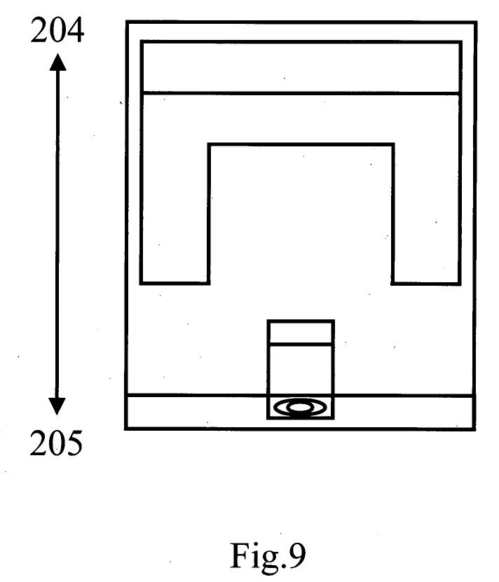

The usage environmental temperature of the magnetic disk drive 100 may change depending on an environment in which the magnetic disk drive 100 lies, and due to heat liberation of the magnetic disk drive 100 itself. For example, the heat liberation of the magnetic disk drive 100 itself generates due to the energization of a coil for a writing head, or due to frictional heat occurring on the air bearing surface 705. Conversely, when the temperature of the head element peripheral portion 2012 of the magnetic head slider 201 has decreased, the magnetic head element portion 202 contracts in the direction that dents the magnetic head element portion 202 in the magnetic head slider 201, so that the fly height between the magnetic head element portion 202 and the storage medium 101 increases. Specifically, the contraction of the magnetic head element portion 202 generates the groove portion to thereby generate a negative pressure. However, the change in the magnitude of fly height due to the contraction of the magnetic head slider 201 is larger than that due to the negative pressure. Consequently, the fly height of the magnetic head element portion 202 increases. Meanwhile, FIG. 9 shows the shape of the air bearing surface of the conventional magnetic head slider. In the conventional magnetic head slider, a rise of temperature causes the head element portion to project, thereby increasing a positive pressure to which the magnetic head slider is subjected. However, because the positive pressure to which the entire magnetic head slider is subjected is small relative to the projection amount of the magnetic head element portion 202, the fly height of the head element portion decreases. Therefore, it is necessary to allow for a margin enough to avoid contact between the head element portion and the storage medium even when the head element portion approaches the storage medium by a deformation of the magnetic head element portion (peripheries) due to change in temperature. Since the design of fly height needs to allow for the margin in this manner, this constitutes a factor inhibiting an increase in the capacity of the magnetic disk drive 100.

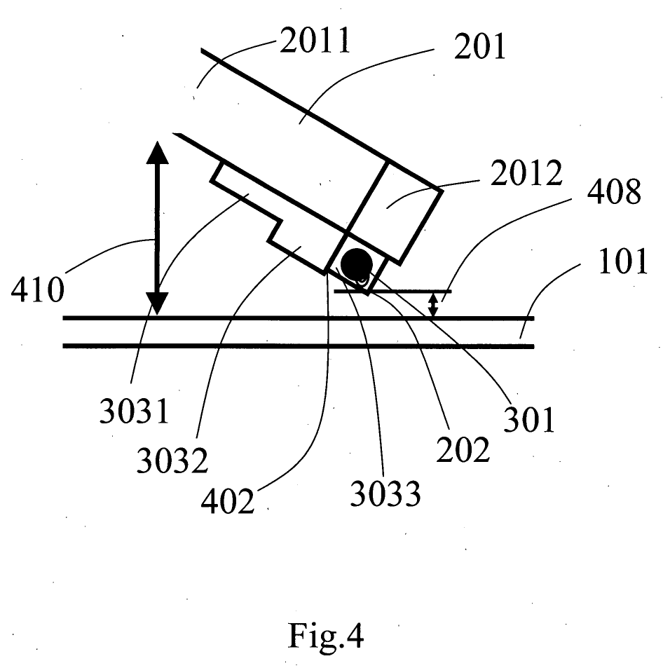

Next, operations of the magnetic head slider 201 according to this embodiment will be explained. FIGS. 4 to 6 are each an enlarged side view of the vicinity of land portions of the magnetic head slider 201 on the side of the air flowing-out edge 205, as viewed from the second land portion 307. The land portions of the slider body 2011 are formed by AlTiC. Between the second step 3072 and the second step 3073 of the second land portion 307, a recess step 402 on the level of 1 nm to several nm is provided as required. The recess step 402 protects the magnetic head element portion 202 and the like from colliding against the storage medium 101 when the fly height of the magnetic head slider 201 changes due to disturbance or the like. Also, the third land portion 303 and the fourth land portion 304 each have an expansion member 301.

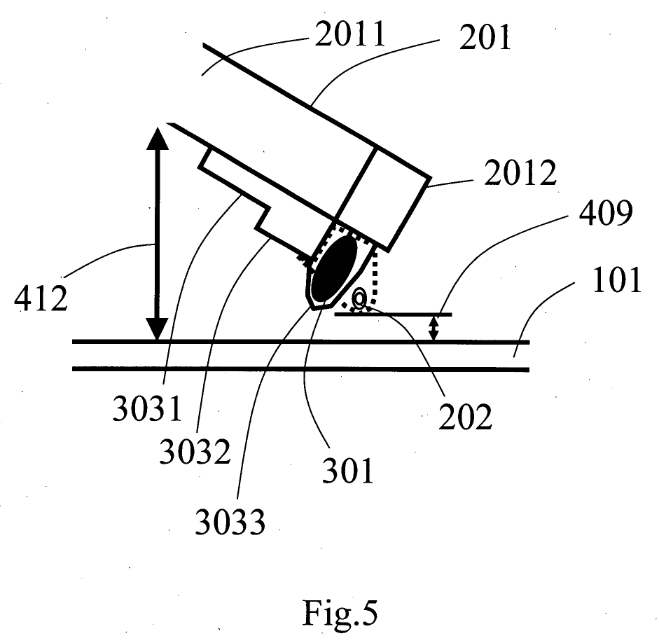

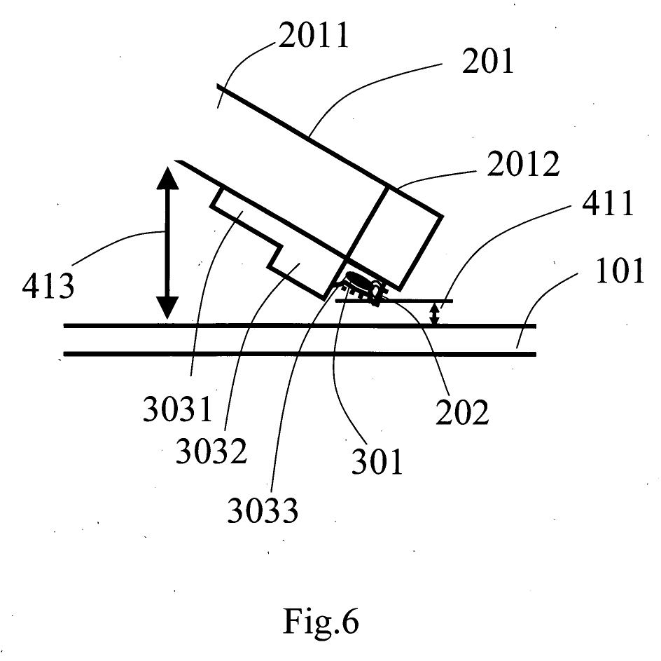

FIG. 4 shows the shape of the head element peripheral portion 2012 at room temperature (25° C.). FIG. 5 shows the shape of the head element peripheral portion 2012 when the environmental temperature thereof has changed to a high temperature. FIG. 6 shows the shape of the head element peripheral portion 2012 when the environmental temperature thereof has changed to a low temperature.

As shown in FIG. 5, when the environmental temperature of the head element peripheral portion 2012 has changed to a high temperature, peripheries of the magnetic head element portion 202 expand. The expansion members 301 expand toward the storage medium 101 due to temperature. The material of expansion members 301 is higher in the thermal expansion coefficient than peripheral materials such as AlTiC. The expansion members 301 each cause a portion of respective one of the third land portion 303 and the fourth land portion 304 to project, thereby forming convex portions. The convex portions formed by the expansion member 301 increases the positive pressure generated in the air bearing surface 705 of the magnetic head slider 201. The fly height 412 of head slider 201 when the environmental temperature has changed to a high temperature becomes higher than the fly height 410 of head slider 201 when the environmental temperature is at room temperature (25° C.). On the other hand, the head element peripheral portion 2012 expands toward the storage medium 101 due to temperature, and the magnetic head element portion 202 approaches the storage medium 101. The change in the fly height of the magnetic head element portion 202 due to the expansion of the vicinity thereof becomes equal to the change in the fly height of the magnetic head slider 201 as a result of the increase in positive pressure due to the expansion of the expansion members 301. As a consequence, even if the environmental temperature of the head element peripheral portion 2012 changes to a high temperature, the fly height 409 of the head element portion of the magnetic head element portion 202 becomes equal to the fly height 408 of head element portion at room temperature, of the magnetic head element portion 202, thereby keeping the fly height constant.

Conversely, when the environmental temperature of the head element peripheral portion 2012 has changed to a low temperature, the head element peripheral portion 2012 contracts in the direction that dents it in the magnetic head slider 201. Each of the expansion members 301 also contracts in the direction that dents it in the magnetic head slider 201, thereby forming respective one of the groove portions (concave portions). The formed groove portions (concave portions) cause the magnetic head slider 201 to generate a negative pressure. Since this negative pressure brings the magnetic head element portion 202 close to the storage medium 101, the fly height 413 of the magnetic head slider 201 decreases. Because the distance by which the magnetic head element portion 202 separates from the storage medium 101 becomes equal to the distance by which the magnetic head slider 201 approaches the storage medium 101, the fly height 411 of the magnetic head element portion 202 is kept constant.

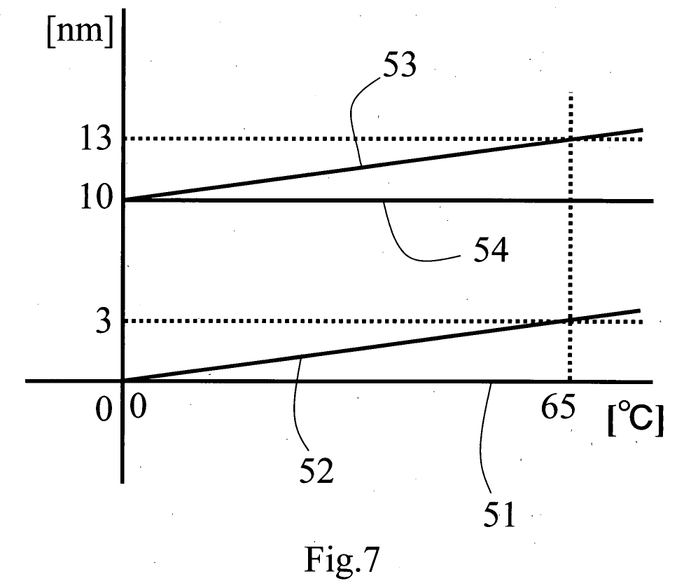

FIG. 7 shows the change of distance with respect to the environmental temperature. The temperature of the magnetic head element portion 202 varies in response to the environmental temperature around the magnetic disk drive 100 and the energization of the head element portion during data writing onto the storage medium. The distance 52 of the magnetic head element portion 202 from the air bearing surface 705 of the magnetic head element portion 202 changes in response to the environmental temperature. This is because the head element peripheral portion 2012 deforms so as to project toward the storage medium 101. At least in the temperature range (0 to 65 degrees) in which the magnetic disk drive 100 operates, the projection amount of the head element portion linearly changes relative to the change of the environmental temperature.

The average distance 53 of the magnetic head slider 201 from the storage medium 101 changes in response to the environmental temperature. This is because the positive pressure in the magnetic head slider 201 increases due to the expansion of the expansion members 301. At least in the temperature range (0 to 65 degrees) in which the magnetic disk drive 100 operates, the average distance 53 of the magnetic head slider 201 from the storage medium 101 changes linearly changes relative to the change of the environmental temperature.

In order to keep constant the fly height of the magnetic head element portion 202 relative to the changing environmental temperature of the magnetic disk drive 100, it can be easily determined by a calculation in advance what size of expansion members should be used. This makes it possible to make a suitable design in response to the shape of the head slider. As a result, the distance 52 and the distance 53 become mutually equal in the dimension and opposite in the direction, and the fly height 54 of the magnetic head element portion 202 over the storage medium 101 becomes constant irrespective of the environmental temperature.

The present invention does not require heating means such as a heater for generating a positive pressure. Therefore, because there is no need to worry about affecting the magnetic head element portion 202, it is possible to dispose the expansion members 301 in the vicinity of the magnetic head element portion 202. Thus, the present invention is characterized in that the restriction on the installation positions of the expansion members 301 is very low. Hence, the shape of the magnetic head slider 201 is not only limited to the shape such that, as in this embodiment, the magnetic head element portion 202 and the expansion members 301 are formed on separate lands, but also the magnetic head slider 201 can have a shape such that the expansion members 301 are disposed on the second land portion 307 having the magnetic head element portion 202, symmetrically with respect to the magnetic head element portion 202.

When the expansion members 301 are disposed on the second land portion 307 having the magnetic head element portion 202, symmetrically with respect to the magnetic head element portion 202, it is possible to reduce a rotational force generated in the magnetic head slider 201. This is because, even if an imbalance occurs between positive pressures generated by the expansion members 301, the distance, from the rotational center at which the magnetic head element portion 202 of the magnetic head slider 201 is disposed, to the application point of force, at which each of the expansion members 301 is disposed, is reduced. This makes it possible to reduce influence of the above-described imbalance of positive pressure on the floating posture of the magnetic head slider 201. Meanwhile, the present invention uses an example in which the first land portion 701 is separated from the third land portion 303 and the fourth land portion 304, each of which is equipped with the expansion member 301. However, the present invention may assume a configuration such that these land portions connect with each other.

Furthermore, it is possible to provide expansion members 301 to the vicinity of the magnetic head element portion 202 on the second land portion 307 having it, and to both of the third land portion 303 and fourth land portion 304, to thereby use these expansion members 301 in combination.

It is also possible to use in combination the expansion members 301 that are mutually different in the thermal expansion coefficient.

When the expansion members 301 that are mutually different in the thermal expansion coefficient are used, the expansion member 301 provided in the vicinity of the magnetic head element portion 202 makes it possible to take advantage of heat generated during the energization at data writing, that is, of a local change in the environmental temperature. For example, the expansion members 301 formed on the third land portion 303 and the fourth land portion 304 expand/contract using an average environmental temperature in which the magnetic disk drive 100 lies, thereby controlling the fly height of the entire magnetic head slider 201. Thus, the expansion member 301 formed on the second land portion 307 having the magnetic head element portion 202 can perform more correct fly height control on the basis of whether the operation is writing or reading on/from the magnetic head element portion 202, by controlling the fly height of the head slider utilizing a local change in the environmental temperature depending on the presence and absence of the passing of a writing current to the magnetic head element portion 202.

Moreover, the expansion member 301 having the magnetic head element portion 202 uses a material higher in the thermal expansion coefficient than that of the magnetic head element portion 202, and is designed so as to more significantly expand or contract in response to temperature than the magnetic head element portion 202, thereby allowing the magnetic head element portion 202 to be prevented from colliding against the storage medium 101 even if the fly height of the magnetic head slider 201 decreases due to disturbances or the like.

As described above, since the fly height of the magnetic head element portion 202 becomes constant irrespective of the environmental temperature, it is possible, by allowing for the deformation of the magnetic head element portion 202, to eliminate the margin that is set so as to avoid contact between the magnetic head element portion 202 and the storage medium 101 even if the magnetic head element portion 202 gets closest to the storage medium 101. Moreover, setting the flying height of the magnetic head element portion 202 to a suitable value can be achieved by a very simple arrangement, using the environmental temperature alone without power consumption. Furthermore, keeping constant the fly height of the magnetic head element portion 202 makes it possible to reduce collision between the magnetic head element portion 202 and the storage medium 101 during data writing/reading, or adhesion of foreign matter to the magnetic head element portion 202.

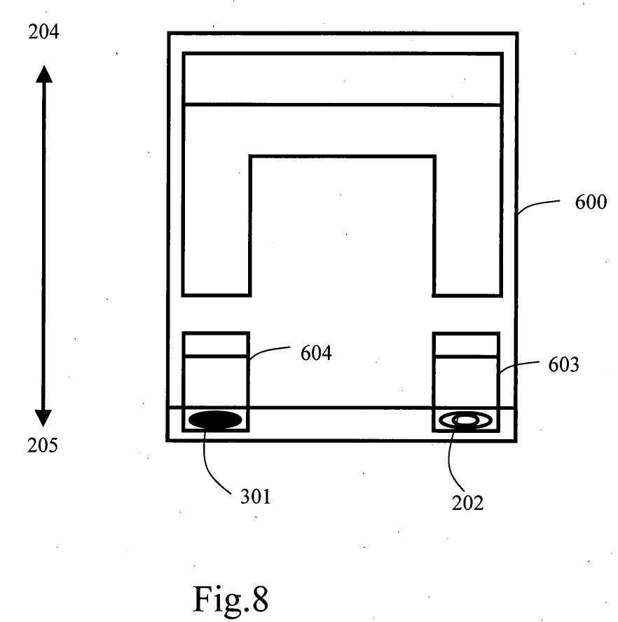

Next, a head slider shown in FIG. 8, according to a second embodiment of the present invention will be described. Here, regarding the same portions as in FIG. 3, which have been used in the explanation of the above-described first embodiment, their description is omitted or simplified.

A magnetic head slider 600 in FIG. 8 has a pair of land portion on both sides of the air flowing-out edge 205. This pair of land portion consists of a fifth land portion 603 and a sixth land portion 604. The head slider body,600 provides the fifth land portion 603 with the magnetic head element portion 202. The head slider body 600 provides the sixth land portion 604 with the expansion member 301. Here, the head slider body 600 may be arranged so as to have a land portion formed along both sides thereof, integrally with the first land portion 701 formed on the side of the air flowing-in edge 204.

The magnetic head slider 201 in FIG. 3 provides the magnetic head element portion 202 in the vicinity of the widthwise center of the magnetic head slider 201 on the side of the air flowing-out edge 205. The magnetic head slider 201 provides the expansion members 301 symmetrically relative to the magnetic head element portion 202. In the magnetic head slider 600, the magnetic head element portion 202 is not disposed in the vicinity of the widthwise center. The magnetic head element portion 202 and the expansion member 301 are disposed so as to be symmetrical relative to the widthwise center.

When the environmental temperature of the head element periphery 6012 increases, peripheries of the magnetic head element portion 202 expand toward the storage medium 101. When the environmental temperature rises, the expansion member 301 formed on the sixth land portion 604 expands and a portion of the fifth land portion 603 projects due to this expansion, so that the magnetic head slider 600 undergoes a positive pressure to thereby move away from the storage medium 101. The difference between the distance from the air bearing surface 705 to the magnetic head element portion 202 at room temperature and the distance from the air bearing surface 705 to the magnetic head element portion 202 at a high temperature, is equal to the difference between the distance from the magnetic head slider 600 to the storage medium 101 at room temperature and the distance from the magnetic head slider 600 to the storage medium 101 at the high temperature. This makes constant the fly height of the magnetic head element portion 202.

Here, regarding the magnetic head slider 600 in FIG. 8, when the positive pressure generated by the expansion of peripheries of the magnetic head element portion 202 on the fifth land portion 603 is not equal to the positive pressure generated by the expansion of the expansion member 301 on the sixth land portion 604, there is a possibility that the magnetic head slider 201 will perform a rotational motion (roll motion) about the rotational axis along the longitudinal direction. This rotational motion can be reduced by designing so that the positive pressure increase due to the expansion of peripheries of the magnetic head element portion 202 on the fifth land portion 603 becomes comparable in magnitude with the positive pressure increase by the expansion of the expansion member 301. However, there is a possibility that the magnitude of the positive pressure to which the magnetic head slider 600 is subjected may be insufficient due to the expansion of the peripheries of the magnetic head element portion 202. This being the case, it is also possible to reduce the rotational motion by providing the fifth land portion 603 with the expansion member 301 as well, to thereby equate the positive pressure generated in the fifth land portion 603 with that generated in the sixth land portion 604, and simultaneously by generating a positive pressure of a requisite magnitude.

When the environmental temperature of the head element periphery 6012 decreases, the magnetic head element portion 202 on the sixth land portion 604 contracts. The expansion member 301 provided on the sixth land portion 604 also contracts. As consequence, the magnetic head slider 600 undergoes negative pressures generated by the fifth land portion 603 and the sixth land portion 604, to thereby approach the storage medium 101. The difference between the distance from the air bearing surface 705 to the magnetic head element portion 202 at room temperature and the distance from the air bearing surface 705 to the magnetic head element portion 202 at a low temperature, is equal to the difference between the distance from the magnetic head slider 600 to the storage medium 101 at room temperature and the distance from the magnetic head slider 600 to the storage medium 101 at the low temperature. This makes constant the fly height of the magnetic head element portion 202. Moreover, by designing the negative pressure due to the denting of magnetic head element portion 202 and the, negative pressure due to the dent of the expansion member 301 to suitable positive pressures of requisite magnitudes, it is also possible to reduce the rotational motion and simultaneously generate a negative pressure of requisite magnitude. Therefore, the second embodiment can produce effects similar to the first embodiment.

The magnetic head slider including at least one expansion member 301, according to the present invention has a simple construction. That is, the present head slider is free of an adverse effect of the energization of the coil upon the magnetic head element portion 202, and further, eliminates the need for a sensor circuit or the like for ascertaining the energization or the fly height. The present head slider, therefore, is capable of installing expansion members 301 on the side of the magnetic head element portion 202, as well.

What is claimed is:

1. A head slider for reading or writing a data to a storage medium, comprising:
a major surface of said head slider to be placed opposite to said storage medium;
a first land portion protruding from said major surface by a predetermined height, for generating a down force bringing said head slider close to said storage medium by an air flow passing through between said head slider and said storage medium; and
a second land portion protruding from said major surface by predetermined height and positioned downstream said first land potion said second land portion having an expansion material, said expansion material having a higher thermal expansion coefficient than a constituent material of said second land portion.

2. The head slider of according to claim 1, whether said head element portion is located near the center of said air flowing-out edge of said head slider, a plurality of said second land portions are located in symmetrical around said head element portion.

3. The head slider of according to claim 1, whether a plurality of said second land portions are located in symmetrical around the center of said air flowing-out edge, said head element portion is located one of said second land portion.

4. A memory device having at least one of recording medium and at least one of head slider for reading or writing with a head element portion a data from or to said recording medium, said head slider comprising:
a major surface of said head slider to be placed opposite to said storage medium;
a first land portion protruding from said major surface by a predetermined height, for generating a down force bringing said head slider close to said storage medium by an air flow passing through between said head slider and said storage medium; and
a second land portion protruding from said major surface by predetermined height and positioned downstream said first land potion said second land portion having an expansion material, said expansion material having a higher thermal expansion coefficient than a constituent material of said second land portion.

5. Said memory device of according to claim 4, whether said head element portion is located near the center of said air flowing-out edge of said head slider, a plurality of said second land portions are located in symmetrical around said head element portion.

6. Said memory device of according to claim 4, whether a plurality of said second land portions are located in symmetrical around the center of said air flowing-out edge, said head element portion is located one of said second land portion.
